(19) United States
(12) Patent Application Publication
(10) Pub. No.: US 2019/0300068 A1
(43) Pub. Date: Oct. 3, 2019

(54) PROTECTIVE FLAP

(71) Applicant: FLAP TEK LTD, Red Deer (CA)

(72) Inventor: Jared Procuik, Lumby (CA)

(21) Appl. No.: 16/369,200

(22) Filed: Mar. 29, 2019

Related U.S. Application Data
(60) Provisional application No. 62/649,741, filed on Mar. 29, 2018.

(51) Int. Cl. B62D 25/18; B62D 25/16

(52) U.S. Cl. CPC B62D 25/18; B62D 25/163; B62D 25/161

(57) ABSTRACT

A protective flap for a vehicle that runs along the arc of the wheel well and is longer than the arc such that a first end of the device is flush with the front end of the wheel well while the second end of the device protrudes out from the rear end of the wheel, thereby forming a flap. The protective flap is dimensioned to cover the entire width of the wheel well along the entire contour of the wheel well. At least a portion of the protective flap is also wider than the width of the wheel well and protrudes from the side of the wheel well. The rear flap and side protruding portion act to block debris that may be hurled out by the vehicle's wheels as the vehicle travels over wet or loose terrain.

### TECHNICAL FIELD

This disclosure relates generally to a protective flap for a vehicle and, more specifically, to a flap which protects the entire length and width of a vehicle wheel well wherein portions thereof extend beyond and below the rear of the wheel well and the side of the vehicle body.

### BACKGROUND

As a vehicle travels over loose or muddy terrain, particularly at higher speeds, a vehicle's spinning wheels may kick up water droplets, dirt, gravel, snow, ice, sand, mud, and other debris. The kicked up debris is sprayed or hurled from out of the rear of the vehicle and out from each of its sides. Such material may create a nuisance or even a hazard to anyone driving behind or beside the vehicle, as it may greatly inhibit their vision. Debris hurled from the vehicle may also hit pedestrians or other nearby vehicles, causing harm.

Not only may the debris cause a nuisance or injury to others and their vehicles, it also hits the vehicle body and may accumulate in the wheel well. Accumulated debris may fall onto the spinning wheel and get repeatedly thrown, potentially causing more damage. The thrown debris may hit the sides and/or rear of the vehicle causing the vehicle to become damaged or dirty.

### BRIEF DESCRIPTION OF THE DRAWINGS

FIG. 1 is a bottom, rear perspective view of an example of a mud flap set as versions of it may be mounted to an exemplary vehicle.

FIG. 2 is a top, side perspective view of an exemplary device, suitable to be attached to the front wheel well of a vehicle.

FIG. 3 is a top, side perspective view of an exemplary device, suitable to be attached to the rear wheel well of a vehicle.

FIG. 4 is a schematic depiction of debris getting kicked up from the ground and hurled as against the protective device.

FIG. 5 is a front, side perspective view of an exemplary device placed inside the rear wheel well of an exemplary vehicle.

FIG. 6 is a top, side perspective view of an exemplary device placed inside the rear wheel well of an exemplary vehicle.

### DETAILED DESCRIPTION

The protective flap for coupling to a wheel well of a vehicle may comprise a body made of a semi-rigid and smooth material and an attaching mechanism to allow attachment of the body to the inside of the wheel well along the arc of the wheel well, the body dimensioned such that the length of the body is longer than the arc of the wheel well such that when the attaching mechanism is used to attach the body to the wheel well one end of the body matches flush with the front end of the wheel well and the opposing end of the body protrudes beyond and below the rear end of the wheel well to protect the undercarriage of the vehicle. The width of the body may be wider than the width of the wheel well such that at least a portion of the body protrudes out from the side of the wheel well, wherein the entire width of the wheel well is covered by the protective flap.

The flap may be made of acrylonitrile butadiene styrene (ABS).

The outside of the rigid flap may have a reflective material applied to it such that the reflective material is visible from behind the vehicle.

The wheel well may be covered by a fender having a plurality of fender apertures. The protective flap may also have a plurality of flap apertures. When the protective flap is placed in a predetermined position the plurality of flap apertures aligns with the plurality of fender apertures. The protective flap may be fastened to the fender by threading a fastener through each of the aligned flap apertures and fender apertures.

The flap may be of unitary construction.

A protective flap assembly may be provided with at least two protective flaps and a plurality of fasteners for attaching the protective flaps to a vehicle.

A detailed description of the figures will be given in the following. It will be appreciated that the figures provided herein are for illustration only and are not meant to be restrictive. Any references to directions such as “up” or “down,” “top” or “bottom” are exemplary and refer only to the directions shown in the figures.

Mud flaps that prevent debris from being hurled behind a vehicle's wheels and into the undercarriage of the vehicle are known. Such flaps are typically made of rubbery material that is susceptible to deformation, particularly when repeatedly hit by debris. Wheel well liners that protect portions of a vehicle's wheel well are also known. However, mud flaps, wheel well liners, and other similar devices may not align to appropriately protect both the undercarriage of the vehicle, the wheel well, and the sides of a vehicle. The examples described herein is a mud flap made of a one-piece sturdy material that will not be damaged when contacted by debris, and will not decay over time. Being a one-piece device, it is simple to install and does not require alignment of separate components. It can protect the entirety of the vehicle wheel well from front to back, and prevents debris and water from being hurled either behind or out from the sides of the vehicle. In a preferred example, the mud flap is made of a material that is smooth at least on the side facing the wheel such that any accumulated debris may be easily washed off. Additionally, the mud flap may comprise a reflective portion along the externally visible portion of the mud flap which increases the visibility of the vehicle at night. This also provides visual appeal to the mud flap and the vehicle as a whole.

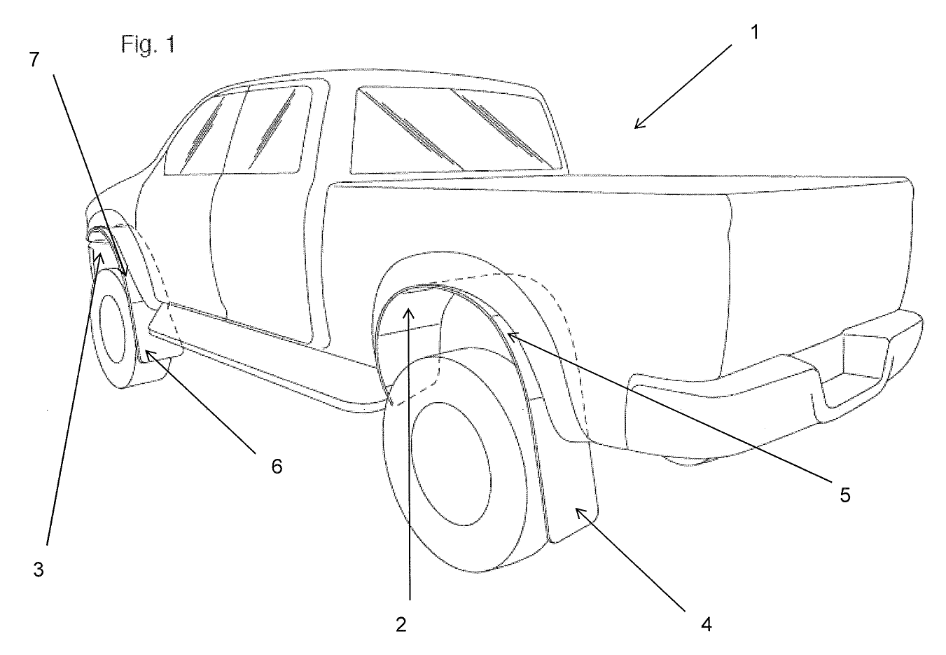

FIG. 1 shows an example as attached to an exemplary vehicle 1. The example shown comprises rear flap 2 and front flap 3 that may be respectively attached to the front and rear wheel wells of vehicle 1. Corresponding flaps, although not shown in FIG. 1, would also be attached to the front and rear wheel wells on the other side of the vehicle.

As can be seen in FIG. 1, flap 2 attaches to the rear wheel well of the vehicle, while flap 3 attaches to the front wheel well. The means of attachment may be by clips, fasteners, or by any other means known in the art.

As shown in FIG. 1, flap 2 runs the entire length, front to back, of the rear wheel well, thereby providing protection to the entire wheel well. As can be seen, a portion of the flap 2 also extends beyond and below the end of the rear wheel well and forms a rear overhang portion 4, which may function as a mud flap. Overhang portion 4 acts to block any materials that may be kicked up by the wheel as it crosses wet or loose terrain.

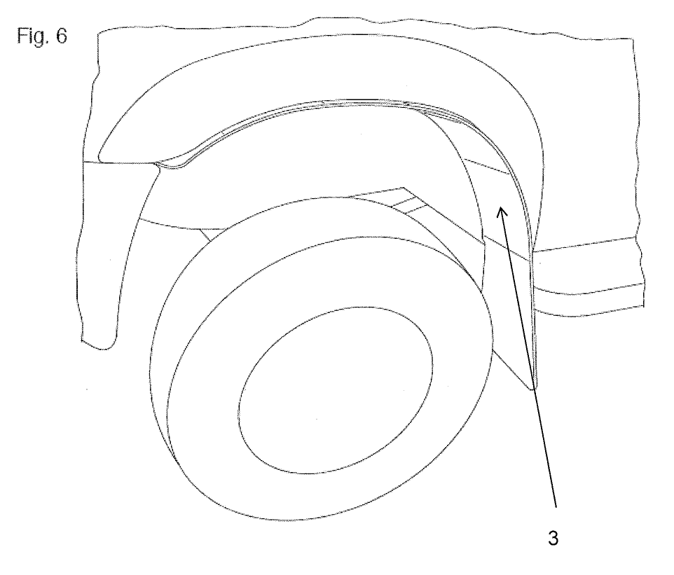

Flap 2 also comprises a side ledge 5 that extends beyond is wider than the wheel well and extends sideways beyond the trim or moulding of the wheel well. In a preferred example, the flap 2 extends about ¾ of an inch beyond the wheel well. The contour of flap 2 preferably mirrors the contour of the edge of the wheel well 15 (see FIG. 5) to provide protection around the entire length of the wheel well while also being aesthetically pleasing. Side ledge 5 acts to protect the body of the vehicle 1 as it blocks materials that may be kicked up and hurled out from the side of the vehicle 1.

Flap 3 acts in a similar manner to flap 2 but is dimensioned to attach to and protect the front wheel well and the surrounding vehicle body. The flap 3 stops short of the front bumper of vehicle 1 and, in this example, does not wrap all the way around to the front. Flap 3 also comprises an overhang portion 6 extending beyond and below the rear end of the wheel well, and a side ledge 7 that is wider than the wheel well and extends sideways out from the wheel well. The overhang portion 6 and side ledge 7 act to block materials that are kicked up by the wheel and flung backwards or out the side.

Both flaps 2 and 3, may be made of a single bent piece of semi-rigid material that will withstand the impact of debris as flung from the vehicle's wheels. In a preferred example, the material is a thermoplastic polymer such as acrylonitrile butadiene styrene (ABS) which is rigid, rugged, and formable around the wheel well. The material is resistant to deformation, even when repeatedly hit by debris. The outside facing portion of the material, that is the portion facing away from the wheel well, has a smooth finish so that any material that may become stuck is easily removed.

Flaps 2 and 3 are preferably dimensioned to cover the entire width of the wheel well so that the wheel well is protected from front to back. Accordingly, flaps 2 and 3 simultaneously provide protection along the entire contour and width of the wheel well, the undercarriage of the vehicle as a result of overhang portion 6, and the side of the vehicle as a result of side ledge 7. By providing a single piece flap that protects all areas in and around the wheel wells, it eliminates the need to have separate components for protecting the various areas. Also, it protects in a seamless way that does not require separate components to be fitted together to provide full coverage for the entire area in and around the wheel well. Installation of the flaps is simplified by having a single component which is fastened or clipped into place, without the need to fit it to or around other protective components such as a separate mud flap or wheel well guard.

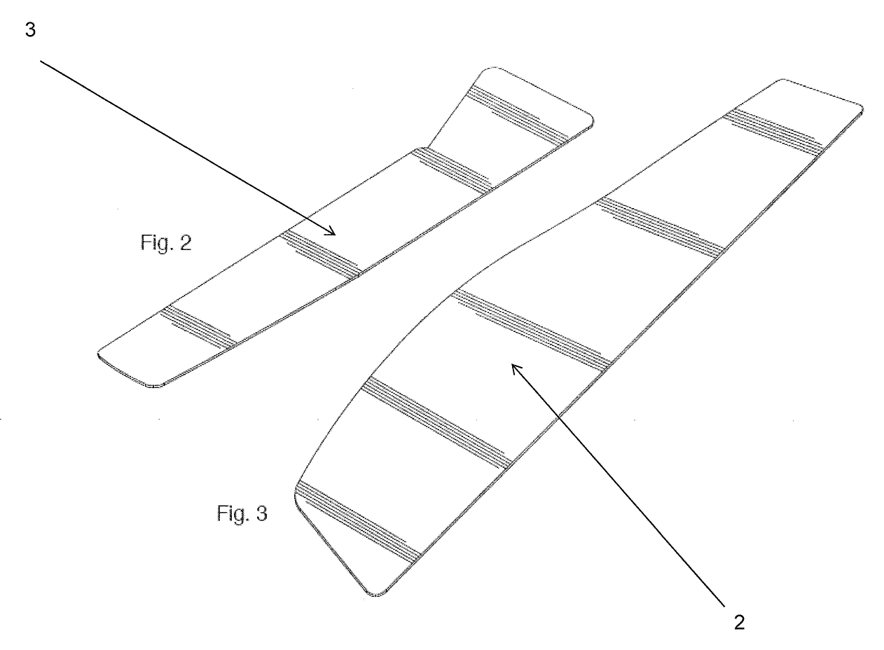

FIGS. 2 and 3 provide an isometric view of flaps 2 and 3, illustrating the shape of the flaps before they are installed. Flaps 2 and 3 are preferably manufactured as a single piece. The size and shape of flaps 2 and 3 will vary based on the shape of the vehicle's wheel wells and body contours. Before installing the flaps, it must be determined what fasteners and holes will be used to fix the flap to the vehicle. Vehicles typically have fasteners and corresponding holes to fix the fender (or sometimes called a fender skirt) to the vehicle. The fasteners and holes may be used to additionally fix flaps 2 and 3 to the vehicle. Other holes may be drilled into the fender skirt or vehicle body for fixing the flaps 2 and 3. The precise number, positioning, and size of the holes (not shown) on the flaps 2 and 3 will vary based on the vehicle the flaps will be attached to. Flaps 2 and 3 may be manufactured with holes which correspond to the holes on the fender skirt or vehicle body. Alternatively, holes may be drilled into flaps 2 and 3.

To install a flap, the following steps may be used. First, one end of the flap is aligned with the front part of the wheel well. The flap is aligned such that the holes in the flap line up with the holes in the fender skirt or vehicle body. If the fender skirt or vehicle body does not have holes to couple the flap to the vehicle, holes may be drilled at spaced intervals along the contour of the wheel well of the vehicle. In many situations, the fender skirt or vehicle body will already have holes provided to attach other components which may be reused to attach the flap. If there are not enough holes to securely couple the flap to the vehicle, additional holes may be drilled. In the examples shown in FIGS. 2 and 3, the flaps are bent to conform with the contour of the wheel well. Once the flaps are placed in a predetermined position where the holes in the flap are aligned with the holes in the fender or vehicle body, a first fastener may be inserted through one of the aligned holes to fix the flap in place. Once the first fastener is fixed, additional fasteners may be inserted through the other aligned holes to firmly fix the flap to the vehicle. The method may include loosening one or more fasteners to allow adjustment of the flap so that it better aligns with the wheel well.

FIG. 5 provides a further isometric view of flap 2 and FIG. 6 provides a further isometric view of flap 3.

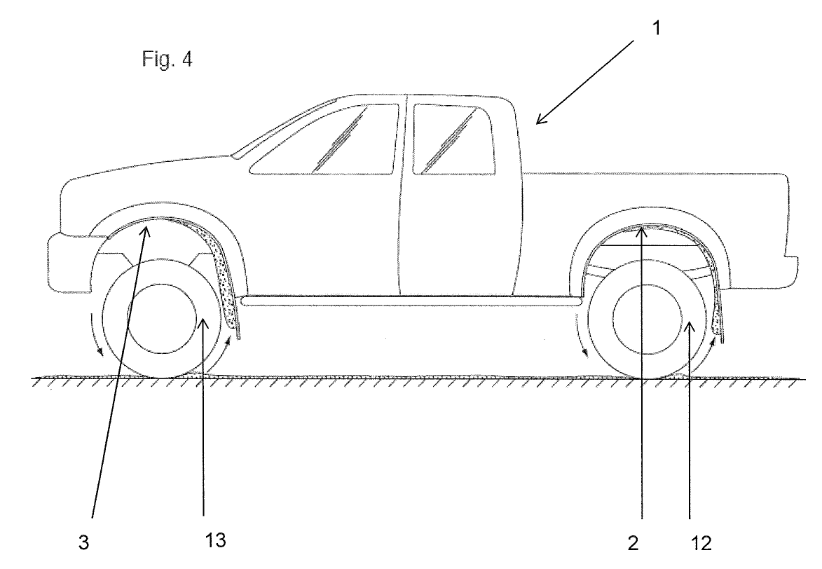

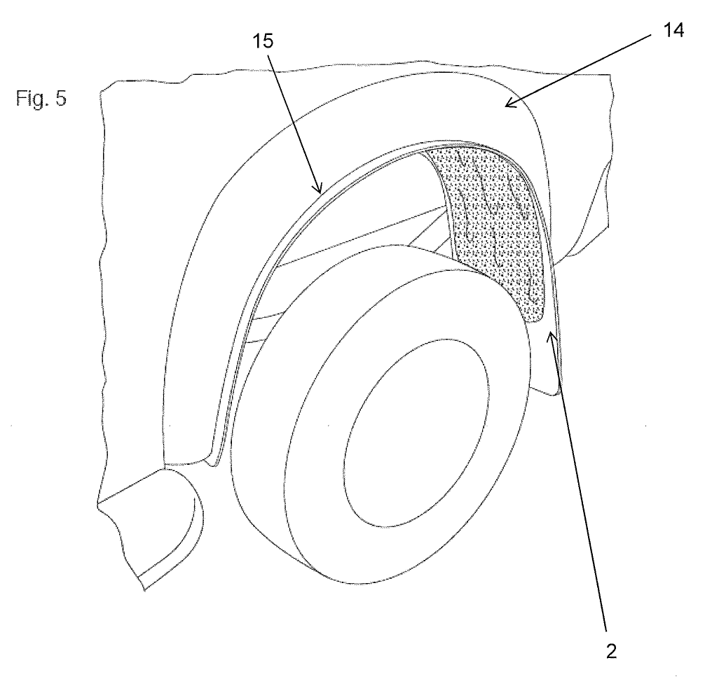

FIG. 4 is a side view of flaps 2 and 3 in operation. As each wheel 12 and 13 of vehicle 1 rotates, dirt, snow, mud and other debris are kicked up from the terrain. The debris are the blocked by flaps 2 and 3 before they can be hurled from the vehicle. Blocking material mitigates the issues discussed above, namely, debris hitting other cars, pedestrians, or inhibiting the vision of other drivers who are following in close proximity to vehicle 1. Additionally, it mitigates against damage to the vehicle 1 wheel wells and vehicle body.

In another example, the overhang portion 4 on flap 2 has applied to it a reflective coating or reflective tape for enhanced night-time visibility, and visual appeal.

The example described herein may be sold as an assembly kit comprising a set of flaps corresponding to the number of wheel wells on a vehicle. Additionally, the kit may comprise a set of fasteners for fastening the flaps to a vehicle.

Although exemplary devices have been described above and are illustrated in the accompanying drawings to be more clearly understood, the above description is made by way of example and is not meant to limit the scope of the claims. It is contemplated that various modifications apparent to one of ordinary skill in the art could be made without departing from the scope of this disclosure which is to be determined by the following claims.

1. A protective flap for coupling to a wheel well of a vehicle, comprising:
a body made of a semi-rigid and smooth material and having an attaching mechanism to allow attachment of the body to an inside of the wheel well along an arc of the wheel well, the body dimensioned such that:
a length of the body is longer than the arc of the wheel well such that when the attaching mechanism attaches the body to the wheel well, one end of the body matches flush with a front end of the wheel well and an opposing end of the body protrudes beyond and below a rear end of the wheel well to protect an undercarriage area of the vehicle;
a width of the body is wider than the width of the wheel well such that at least a portion of the body protrudes out from the side of the wheel well, wherein the entire width of the wheel well is covered by the protective flap.

2. The protective flap of claim 1, wherein the semi-rigid and smooth material is acrylonitrile butadiene styrene.

3. The protective flap of claim 1, wherein an outside of the rigid flap comprises a reflective material such that the reflective material is visible from behind the vehicle.

4. The protective flap of claim 1, wherein the wheel well is covered by a fender, the fender comprising a plurality of fender apertures, wherein the protective flap comprises a plurality of flap apertures, wherein when the protective flap is placed in a predetermined position the plurality of flap apertures aligns with the plurality of fender apertures, and wherein the protective flap is fastened to the fender by threading a fastener through each of the aligned flap apertures and fender apertures.

5. The protective flap of claim 1, wherein the protective flap is of unitary construction.

6. A protective flap assembly comprising at least two protective flaps of claim 1, and a plurality of fasteners for attaching said protective flaps to a vehicle.

7. The protective flap of claim 2, wherein an outside of the rigid flap comprises a reflective material such that the reflective material is visible from behind the vehicle.

8. The protective flap of claim 2, wherein the wheel well is covered by a fender, the fender comprising a plurality of fender apertures, wherein the protective flap comprises a plurality of flap apertures, wherein when the protective flap is placed in a predetermined position the plurality of flap apertures aligns with the plurality of fender apertures, and wherein the protective flap is fastened to the fender by threading a fastener through each of the aligned flap apertures and fender apertures.

9. The protective flap of claim 3, wherein the wheel well is covered by a fender, the fender comprising a plurality of fender apertures, wherein the protective flap comprises a plurality of flap apertures, wherein when the protective flap is placed in a predetermined position the plurality of flap apertures aligns with the plurality of fender apertures, and wherein the protective flap is fastened to the fender by threading a fastener through each of the aligned flap apertures and fender apertures.

10. The protective flap of claim 2, wherein the protective flap is of unitary construction.

11. The protective flap of claim 3, wherein the protective flap is of unitary construction.

12. The protective flap of claim 4, wherein the protective flap is of unitary construction.

13. A protective flap assembly comprising at least two protective flaps of claim 2, and a plurality of fasteners for attaching said protective flaps to a vehicle.

14. A protective flap assembly comprising at least two protective flaps of claim 3, and a plurality of fasteners for attaching said protective flaps to a vehicle.

15. A protective flap assembly comprising at least two protective flaps of claim 4, and a plurality of fasteners for attaching said protective flaps to a vehicle.

16. A protective flap assembly comprising at least two protective flaps of claim 5, and a plurality of fasteners for attaching said protective flaps to a vehicle.
